(19) United States
(12) Patent Application Publication
(10) Pub. No.: US 2026/0027470 A1
(43) Pub. Date: Jan. 29, 2026

(54) Using Volumetric Representations of Objects from Video to Insert User-Generated Content Into Video

(71) Applicant: Sony Interactive Entertainment Inc., Tokyo (JP)

(72) Inventors: Michael Taylor, San Mateo, CA (US); Mihee Kang, San Mateo, CA (US); Maito Omori, San Mateo, CA (US); Xinyu Zhang, San Mateo, CA (US); Shun Terasaki, San Mateo, CA (US); Akihiro Takano, San Mateo, CA (US)

(21) Appl. No.: 18/780,973

(22) Filed: Jul. 23, 2024

(51) Int. Cl. A63F 13/63; G06V 10/70

(52) U.S. Cl. CPC A63F 13/63; G06V 10/768

(57) ABSTRACT

A technique for generating, from a video, a three dimensional (3D) representation of space in which Gaussians represent objects in the video. User-input content such as a hand-drawn game path is inserted into the 3D representation of space and aligned and scaled. The opacity of the Gaussians in the 3D representation of space is then set to zero such that Gaussians representing objects in the video are transparent and only one or more portions of the user-input content are not transparent. The 3D representation of space is then combined with the video so that the user-input content is presented with the video.

### FIELD

The present application relates generally to using volumetric representations of objects learned from video to insert user-generated content into the video.

### BACKGROUND

People who enjoy computer games often value interaction from coaches who can illustrate better gaming techniques using annotated versions of recorded games.

### SUMMARY

As also understood herein, it would be desirable to insert user-input content into video in a realistic manner that makes the user-input content appear as if it were part of the original video. Note that the video may be, for instance, game video, movie video, and real-time streaming game video from other players.

Accordingly, an apparatus includes at least one processor system configured to receive information from video, and using the information, convert at least one scene in the video to a three-dimensional (3D) representation of space which includes at least a first volumetric representation of at least a first object in the video. The system is configured to receive user-input content and insert the user-input content into the 3D representation of space. Furthermore, the system is configured to, responsive to identifying at least a first portion of the user-input content as being occluded by the first volumetric representation, not render the first portion of the user-input content. Additionally, the processor system is configured to set opacity of the first volumetric representation to zero, and overlay the user-input content with first volumetric representation whose opacity is zero onto the video for presentation of the video with the user-input content.

In examples, the first volumetric representation can include a spatially localized basis function such as Gaussians. The user-input content can include one or more of a drawing of a path through a game world, a texture, a 2D object. The processor system may be configured to convert the user-input content to a Gaussian representation.

In some examples the processor assembly may be configured to use a combination of motion vectors and semantic information about objects in the video to identify at least a first object with which to align the user-input content, and then align the user-input content with Gaussians of the first object in the 3D representation of space. The semantic information may include geometry/shape correspondence of the first object and color/texture correspondence of the first object.

In example embodiments the processor system can be configured to prune at least some Gaussians from the 3D representation of space prior to inserting the user-input content into the 3D representation of space. The pruning may be done on the basis of opacity of the Gaussians.

In another aspect, a method includes generating, from a video, a three dimensional (3D) representation of space which includes Gaussians representing objects in the video. The method also includes inserting into the 3D representation of space a user-input content. Moreover, the method includes setting opacity of Gaussians in the 3D representation of space to zero such that Gaussians representing objects in the video are transparent and only one or more portions of the user-input content are not transparent. The method contemplates combining the 3D representation of space with the video.

In another aspect, a device includes computer memory that is/are not a transitory signal and that in turn includes instructions executable by at least one processor system to create, from a video, a three dimensional (3D) representation of space. The 3D representation of space includes volumetric representations of objects in the video. The instructions are executable to receive user-input content into the 3D representation of space, make the volumetric representations transparent, and then combine the 3D representation of space with the video such that the user-input content appears with the video but the volumetric representations do not.

In some examples the instructions may be executable to align the user-input content with at least one of the volumetric representations, and responsive to a portion of the user-input content being blocked from a camera view by one of the volumetric representations, set an opacity of the portion to zero.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates a screen shot of a display showing example user-input content appearing as being part of a 3D representation of a video;

FIG. 3 illustrates another screen shot of a display showing additional example user-input content appearing as being part of a video;

FIG. 4 illustrates example logic in example flow chart format;

FIG. 5 illustrates example logic in example flow chart format for initializing a 3D representation of video without using computer game metadata;

FIG. 6 illustrates example logic in example flow chart format for initializing a 3D representation of video using computer game metadata;

FIG. 7 illustrates further example overall logic in example flow chart format;

FIG. 8 illustrates details of logic from FIG. 7 in example flow chart format in which rectilinear blocks represent processing blocks and oval blocks represent output products;

FIG. 9 illustrates further details of logic from FIG. 7 in example flow chart format in which rectilinear blocks represent processing blocks and oval blocks represent output products;

FIG. 10 illustrates example training logic in example flow chart format;

FIG. 11 illustrates example primitives in relation to the logic of FIG. 9;

FIG. 12 illustrates example alignment details in example flow chart format;

FIG. 13 illustrates alignment diagrams consistent with FIG. 12;

FIG. 14 illustrates example details of mapping coordinates in example flow chart format;

FIG. 15 illustrates mapping diagrams consistent with FIG. 14;

FIG. 16 illustrates mapping diagrams consistent with FIG. 9;

FIGS. 17 and 18 illustrate user-input content from a bird's eye view and third person view, respectively, illustrating differences in occlusion of the user-input content depending on camera view;

FIGS. 19 and 20 illustrate respective bird's eye and third person views of user-indicated desire to create a path between two objects in the 3D representation of space while

FIGS. 21 and 22 illustrate respective bird's eye and third person views of the resultant path or trajectory that the system may automatically construct based on the user-indicated desire;

FIG. 23 illustrates example logic in example flow chart format for animating user-input content based on game metadata;

FIGS. 24-28 illustrate animating and/or altering user-input content according to game scene metadata consistent with FIG. 23;

FIG. 29 illustrates example logic in example flow chart format for highlighting user-input content according to share group settings;

FIG. 30 illustrates an example screen shot consistent with FIG. 29;

FIG. 31 illustrates example logic in example flow chart format for incorporating user-input content in the form of a mesh into a game scene; and

FIG. 32 illustrates example logic in example flow chart format for incorporating user-input content into an appropriate volumetric representation to match that of a game scene.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single-or multi-chip processor that can execute logic by means of various lines such as address lines, data lines, and control lines and registers and shift registers. A processor including a digital signal processor (DSP) may be an embodiment of circuitry. A processor system may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

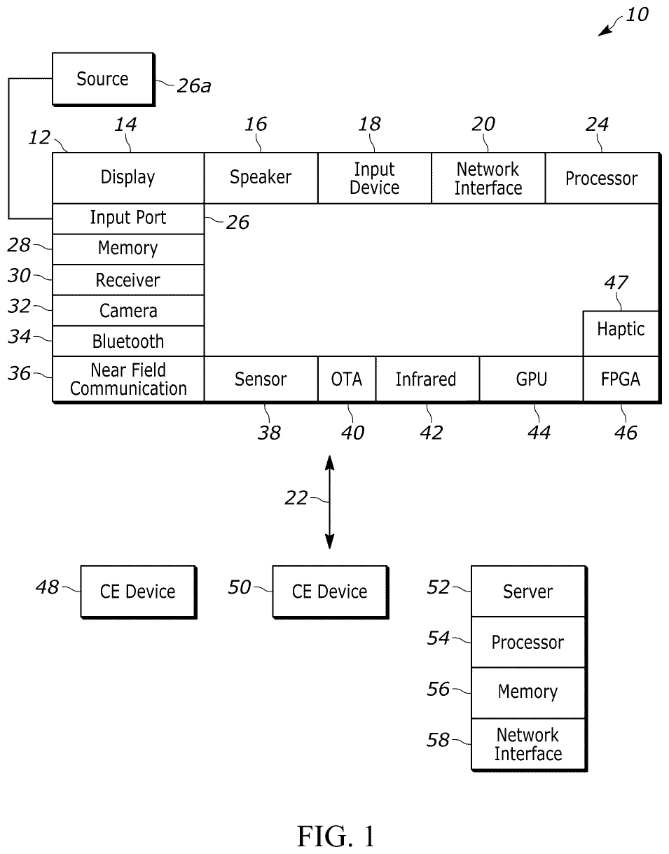

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that are configured and weighted to make inferences about an appropriate output.

According to present principles, a parametrization of 3D space represented by a video such as a motion picture video or a computer game video may be established by a neural representation. For example, the neural representation may be composed of one or more Gaussian or Wavelet volumetric representations, which are examples of bandlimited parameterized signals. A set of Gaussians or Wavelets may be composed together to represent objects and the geometry of a scene. Gaussians and Wavelets are examples of spatially localized basis functions.

Additionally or alternatively, the neural representation may include a neural network, such as a neural radiance field (NeRF). As another example, the parametrization may be established by a 3D mesh. The parameterization may be changed to represent user input within the virtual 3D space as a drawing anchored to an object, where the drawing may be assigned a translated or rotated geometry within the virtual 3D space and in relation to the object. The drawing itself might be represented as digital chalk.

In specific examples described herein, Gaussian representations (or “Gaussians” for short) are used for orienting and positioning user-input objects in 3D space, for occlusion to give the illusion of the inserted object existing in the 3D space behind or partially behind objects from the video, and tracking moving objects in the 3D space. Instead of rendering the learned Gaussian representation, the opacity of all learned Gaussians representing objects from the original video is set to zero and only the inserted object is rendered as a mask over the original video. Occlusion may be calculated on a frame-by-frame basis to handle dynamic content and a moving camera. Learned segmentation is used to group Gaussians for simulating occlusion by objects in the original video.

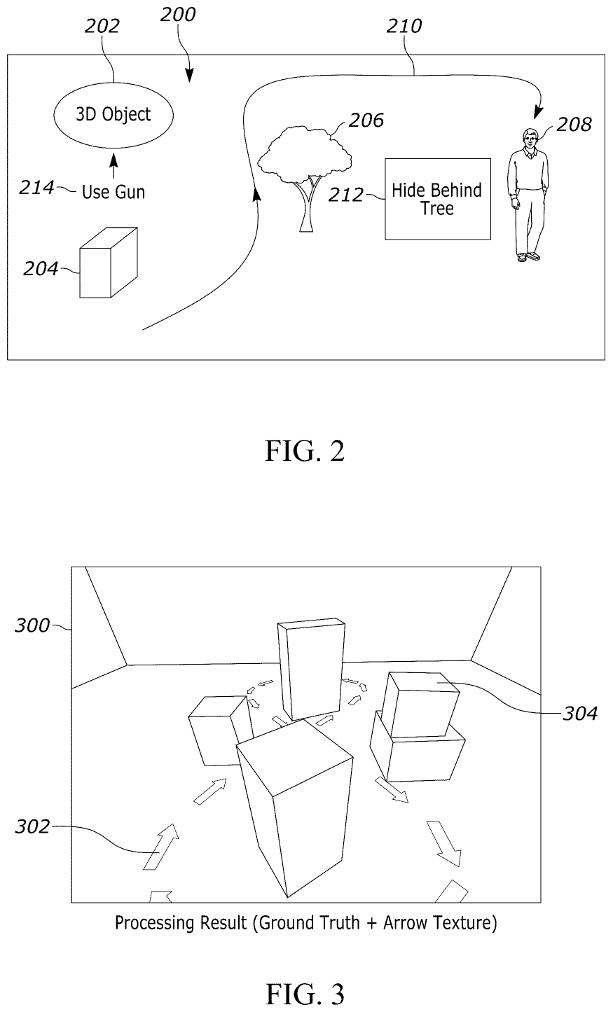

FIGS. 2 and 3 illustrate. In FIG. 2, a 3D representation of space 200 is shown in which volumetric representations of objects 202 in a 2D video are generated. In the example shown, the volumetric representations represents a generic 3D object 202, a box 204, a tree 206, and a character 208.

User-input content 210, in the example shown, a path through the space, has been input by means of, e.g., a suitable input device emulating digital chalk and is shown in the 3D representation. Additional user-input content 212, 214 in the form of a message or post-it note to provide instructions to a gamer is also shown. Other user-input content such as textures, 2D objects, or indeed Gaussian representations of user-input content may be used.

As discussed further below, once the user-input content is aligned with and incorporated into the 3D space, the volumetric representations are rendered transparent by, e.g., setting their opacity (such as alpha values) to zero. Only the user-input content remains opaque. Then, the resulting image is combined with an original video from whence the 3D representation of space was derived to combine the user-input content with the original video as if it were part of the original video, essentially by overlaying the 3D space with transparent volumetric representations onto the video as a mask.

FIG. 3 illustrates an example result. An original video 300 has been combined with user-input content 302 (another path around objects in the video) as shown with portions of the user-input content 302 occluded by foreground or intervening portions of the video objects 304.

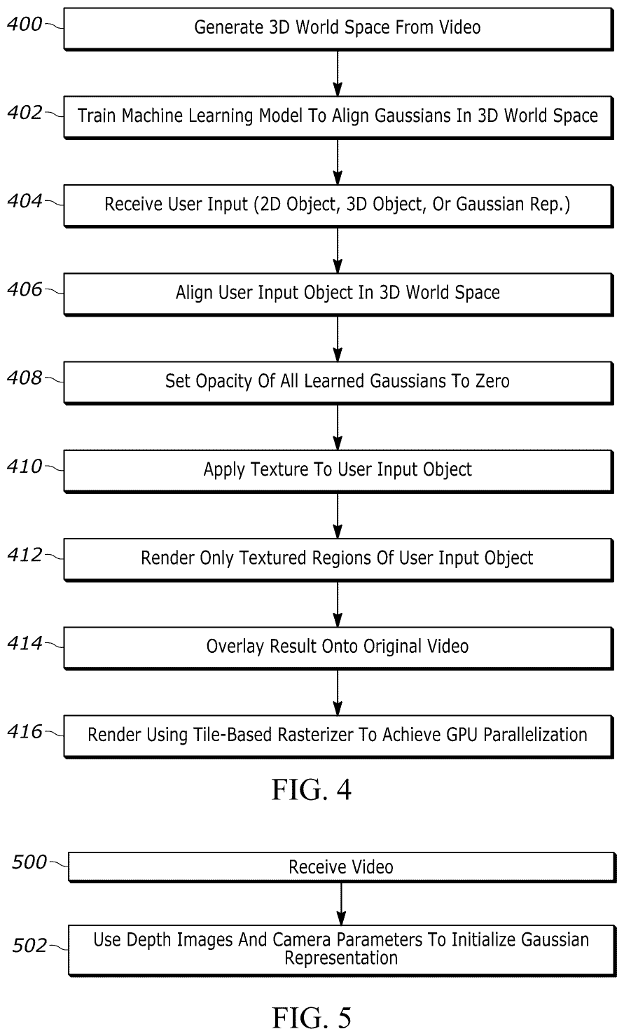

Turn now to FIG. 4 for a first example of overall logic consistent with present principles for creating a 3D representation of a video. The 3D representation is used as a working copy into which user-input content is received, aligned, and scaled according to volumetric representations (such as Gaussians) of objects in the video as reflected in the 3D representation. Then, the volumetric representations (such as Gaussians) are made transparent and the resulting mask superimposed on the original video to show the user-input content as if it were part of the original video.

Present techniques facilitate responding to events in the video as they happen based on 3D object representations plus time indicating movement using Gaussian splatting. In Gaussian Splatting, properties of each Gaussian (center position x/y/z, co-variance matrix (shape) (consists of scaling matrix and rotation matrix), spherical harmonics (color)), and opacity during the backwards error pass) are learned using, e.g., a gradient-based optimization method. A group of Gaussians defines and object in the 3D representation. Note that in addition to using Gaussians to represent objects in the original video, a 3D Gaussian version of the user-input content may be generated and inserted into the 3D representation of the video.

In this way, among other use cases video editing, making video objects for a community, and drawings heat maps and paths on a game video are made possible.

Essentially, present techniques initialize a 3D representation of a video based on Gaussians, which are then moved, aligned, and scaled to create a 3D space full of Gaussians.

Commencing at state 400, a command to generate 3D world or representation of a video is identified. Moving to state 402, a ML model is trained to align and otherwise modify Gaussians in the 3D representation as appropriate to represent objects in the original video. In doing this, a combination of motion vectors and semantic information about the objects is used to decide which objects to align user-input content with. Semantic information can include geometry/shape correspondence, color/texture correspondence, latent feature correspondence, etc.

The user-input content is received at state 404 and aligned and scaled with the Gaussians in the 3D representation of space at state 406. The user-input content may be a 2D object such as a drawing of a recommended game path, a 3D object, a texture, or a Gaussian representation of any of these.

Once the user-input content has been aligned and scaled, the logic moves to state 408 to set the opacity of all learned Gaussians representing objects in the original video to zero, i.e., to make them all transparent. A texture may be applied to portions of the user-input content at state 410 that are not occluded by intervening Gaussians depending on the camera view, and then only the textured regions of the user-input content are rendered at state 412. The resulting mask is combined at state 414 with the original video as by overlaying the mask onto the video and the original video with inserted user-input content is rendered at state 416 using, e.g., a tile-based rasterizer to achieve GPU parallelization.

Turn now to FIG. 5. Commencing at state 500, a video such as a non-game video or a game video without metadata is received. Proceeding to state 502, using depth images and camera parameters inferred from the video, a Gaussian representation of the 3D space represented by the video is initialized.

In one example, this may be done by a differentiable method that solves for camera poses and other parameters and per-frame depth of a video sequence. Gradient-descent minimization can be implemented on the video using a least-squares technique that compares the optical flow induced by camera parameters against correspondences obtained using the optical flow from the video and point tracking. Additionally, differentiable re-parameterizations of depth, intrinsics, and pose may be used for optimization to facilitate Gaussian Splatting. COLMAP techniques alternatively may be used.

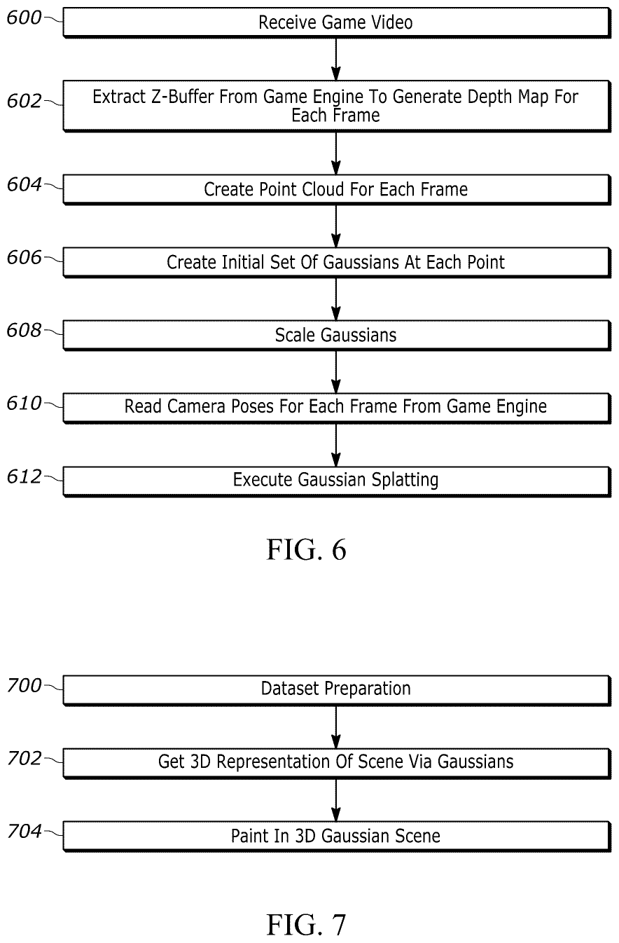

Turn now to FIG. 6. Commencing at state 600 a computer game video with metadata accessible from the game engine is received. Moving to state 602, the z-buffer is extracted from game engine shader pipeline to generate a depth map for each frame.

Proceeding to state 604, a point cloud is created for at least the first frame. One technique for generating the point cloud is to do so uniformly over each 3D space occupied by an object based on the depth maps generated by multiple camera views of a frame. Another technique to generate the point cloud is to do so by extracting out the scene geometry (meshes) from the shader pipeline, and then down-sampling the number of mesh vertexes into a point cloud representation. Note that to generate point clouds from multiple camera views, in addition to the depth map, camera parameters should be received.

Once the point cloud is created, state 606 indicates that an initial set of Gaussians is created for each point in the cloud. Moving to state 608, the Gaussians may be scaled based on surface normals if they are present from the first technique that can be employed at state 604, or the Gaussians may be scaled based on vertex normals if the second technique is used from state 604.

Proceeding from state 608 to state 610, camera poses are read from the game engine for each frame. Using the scaled Gaussians and camera poses, Gaussian splatting is executed at state 612.

FIGS. 7-9 present another aspect of logic consistent with present principles. FIG. 7 show an overall process in which a dataset is prepared at state 700, a 3D representation of a video (or scene thereof) is generated at state 702, and then the user-input content is “painted” into the 3D Gaussian scene at state 704.

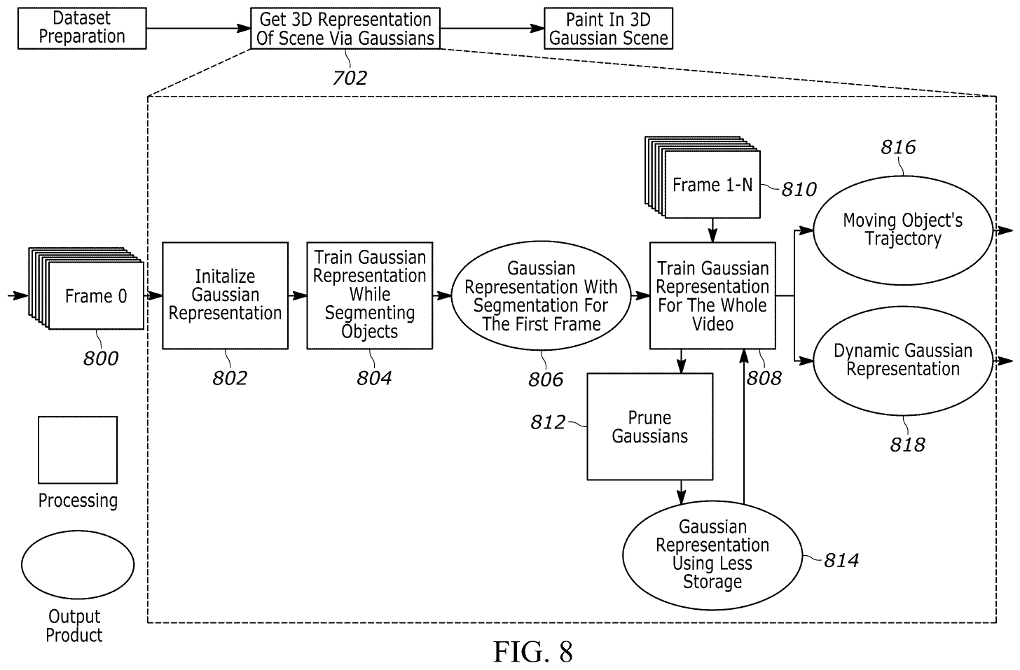

FIG. 8 expands on the operations of state 702 in FIG. 7. Video frames 800 are input to state 802 to initialize a 3D representation of the video space, e.g., using Gaussians. The Gaussian representation so initialized is trained at state 804 while segmenting objects within the 3D representation.

Segmentation may be done using 2D image segmentation and applying learned features to the 3D Gaussians. In a non-limiting example, this can be based on 3D Gaussian Splatting which attaches an affinity feature to each 3D Gaussian. A scale-aware contrastive training strategy distills a segmentation capability of a model from 2D masks into the affinity features and uses a gate mechanism to resolve ambiguity in 3D segmentation by adjusting magnitudes of feature channels according to a 3D physical scale. State 806 represents the segmented Gaussian output of sate 804 for the first frame, which is used at state 808 to then train the Gaussian representation for the entire video 810.

State 812 indicates that training may be associated with pruning away Gaussians from the representation to output a Gaussian representation 814 with less storage requirements than the unpruned Gaussian representation. Gaussians may be pruned based on opacity, e.g., by removing certain Gaussians whose opacity falls below a threshold, or alternatively whose opacity is above a threshold.

The pruned Gaussian representation is then processed to output at 816 a trajectory of any moving objects in the Gaussian representation along with a dynamic Gaussian representation 818 of the video.

The trajectories 816 of moving objects may be identified using motion vectors, for instance. In a specific embodiment a combination of motion vectors and semantic information including the geometry, shape, texture, and color of individual objects may be used to identify which objects are moving and their trajectories.

The dynamic Gaussian representation 818 of the first frame may be used as a basis. To specify Gaussians that should be moved from one frame to the next, the segmentation result may be used to get the moving object directly. Every moving object may be obtained in this way and their trajectories calculated in a straightforward manner.

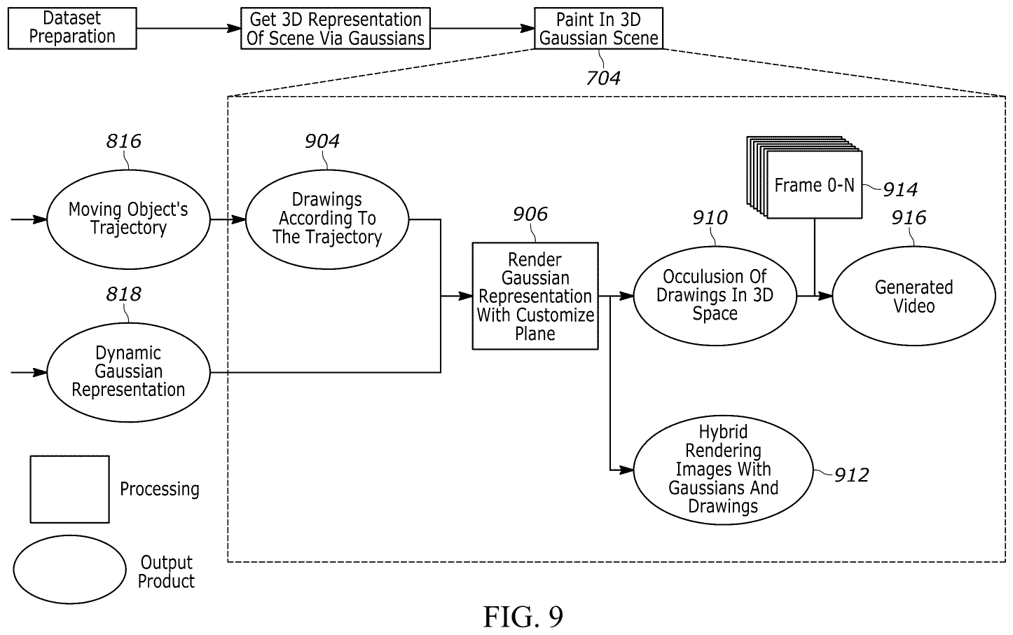

FIG. 9 expands on the operations of state 704 in FIG. 7 and receives the trajectories 816 and dynamic Gaussian representation 818 from FIG. 8. Drawings according to the trajectories are generated at state 904. The drawings from state 904 and the dynamic Gaussian representation 818 are processed at state 906 to render the Gaussian representation with a customized plane. This produces occlusions of the drawings in 3D space 910 and hybrid rendering images with Gaussians and drawings 912, i.e., portions of the user-input content that are blocked by intervening objects in the 3D representation are indicated as being occluded so that those portions do not appear in the video 916 generated from the video frames 914. This may be done on a frame-by-frame basis.

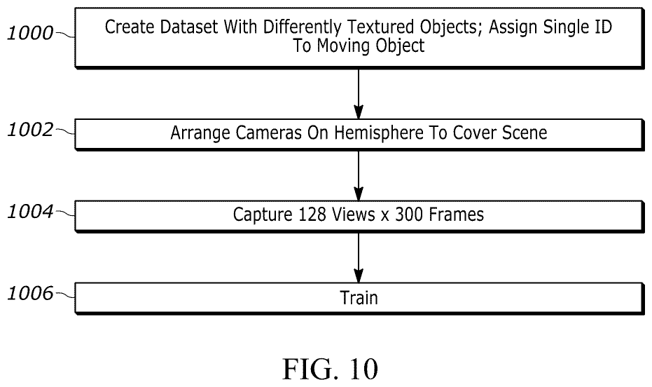

FIG. 10 illustrates example dataset creation. Commencing at state 1000, a dataset is created with differently textured objects. An ID may be assigned to each moving object in the dataset. In some cases a single ID is assigned to each moving object.

Proceeding to state 1002, virtual cameras are arranged in a spiral on a hemisphere to cover the scene. To tarin, at state 1004 N views (e.g., 128) or M frames (e.g., 300 frames) are captured from a frame engine to train the ML model at state 1006.

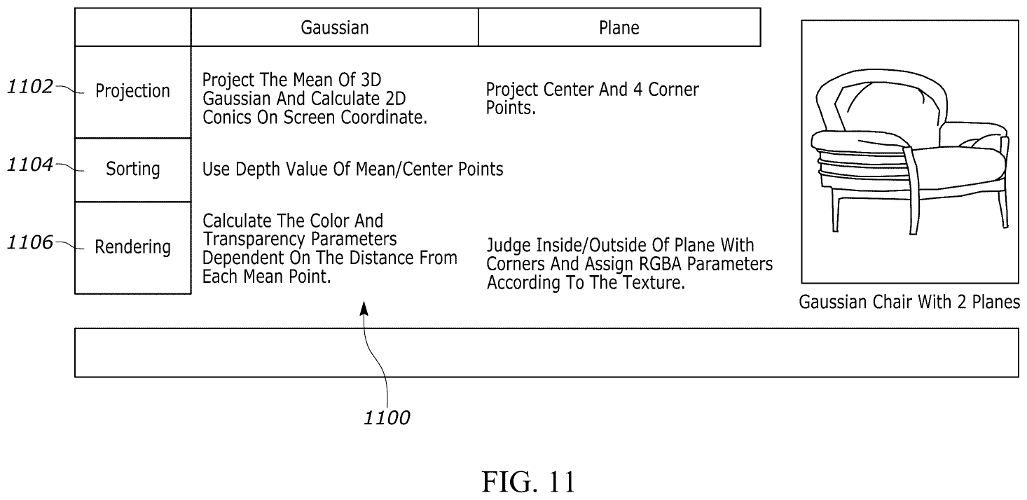

FIG. 11 illustrates principles of inserting primitives representing user-input content into the Gaussian representation of the video. Primitives may include planes, cubes, and other geometric shapes such as 2D arrows that may be input to indicate to a novice where to go in a game. The primitives are projected, sorted, and rendered analogously to the Gaussians.

More specifically, the table 1100 in FIG. 11 includes a projection row 1102 indicating that the mean if a 3D Gaussian is projected and 2D concise on the screen coordinates are calculated, whereas for a planar primitive the center and four corner points are projected. Also, the table 100 includes a sorting row 1104 indicating that for both Gaussians and a plane a depth value of the mean and center points is used for sorting. Further, a rendering row 1106 indicates that for Gaussian rendering, the color and transparency parameters are calculated based on the distance from each mean point, while for planar rendering the inside and outside of the plane are judged with corners and a RGBA value assigned according to the texture of the plane.

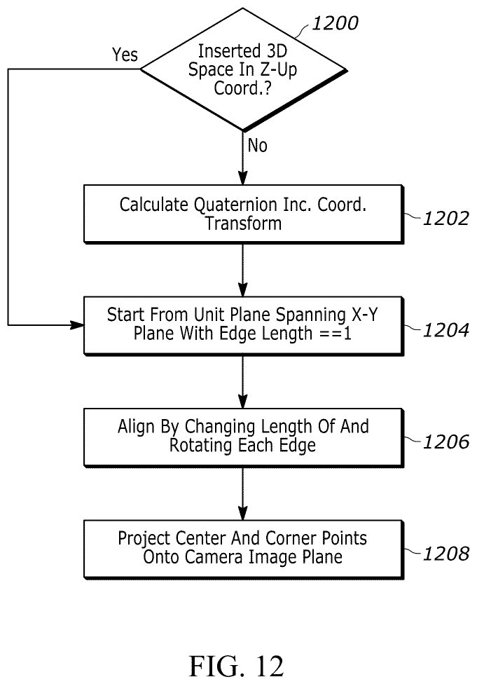

FIG. 12 illustrates further principles related to FIG. 11. If it is determined at state 1200 that the object to be inserted into 3D space is not in Z-up coordinates, the quarternion including a coordinate transformation is calculated at state 1202 to produce a Z-up result. From state 1202 or from state 1200 if Z-up coordinates are found to be present there the logic moves to state 1204 to start from a unit plane spanning the XY plane with length==1 for the edges. Alignment can thus be expressed by changing the length of each edge and rotating the edge at state 1206. Once the position and orientation in 3D space are determined, the logic moves to state 1208 to project the center and corner points onto the camera image plane.

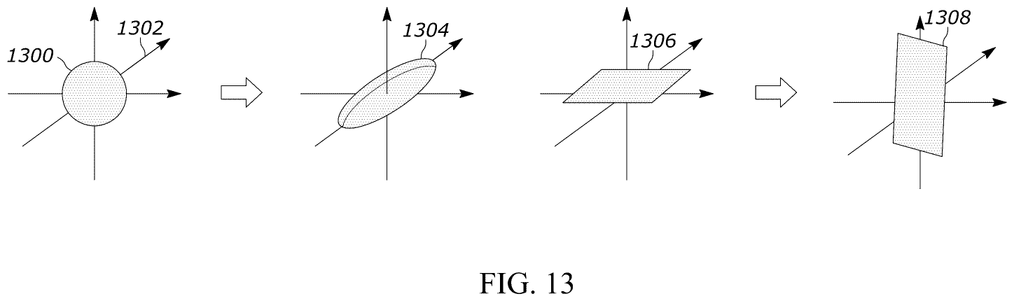

FIG. 13 illustrates the logic of FIG. 12, showing a sphere 1300 in a Cartesian coordinate system 1302 transformed to an oblong object 1304 which in turn is transformed into a plane 1306 the length and orientation of whose edges are moved as indicated at 1308.

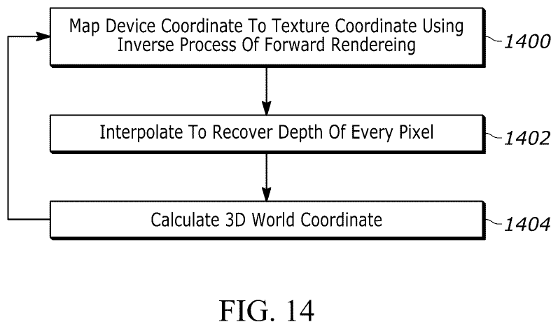

FIG. 14 illustrates still further principles of inserting primitives into the Gaussian representation. Commencing at state 1400, using a complete inverse process or forward rendering, device coordinates are mapped to texture coordinates. Because world coordinates must be calculated as an intermediate result, the depth of every pixel is recovered by interpolation at state 1402 and the world coordinates calculated at state 1404 to obtain the final device coordinates. Because the texture has RGBA information, it may be used to represent any arbitrary 2D shape by setting its alpha channel to zero as appropriate for the desired shape.

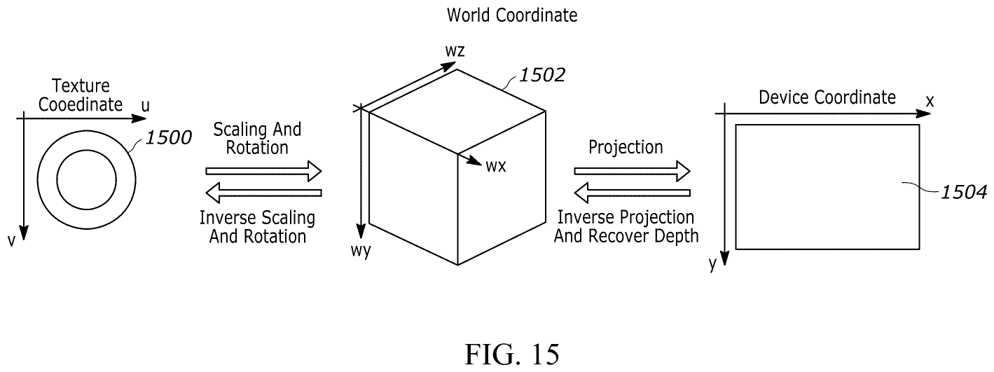

FIG. 15 illustrates further. A texture coordinate 1500 is scaled and rotated to a 3D world coordinate 1502 which is projected into a 2D device coordinate 1504. Inverse scaling and rotation and inverse projection and depth recovery are respectively used between coordinate 1500 and 1502 and 1502 and 1504 as described above.

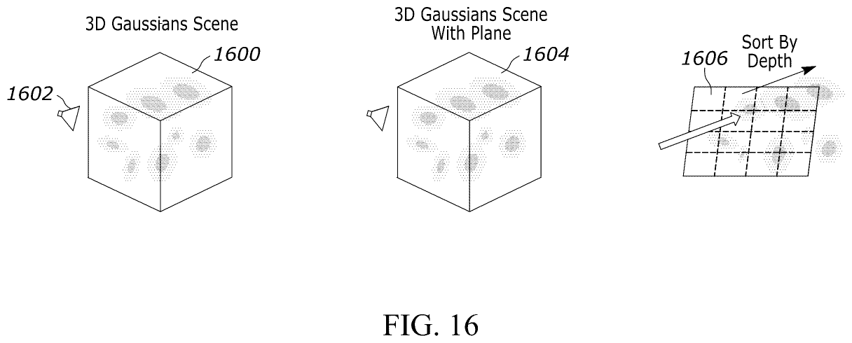

FIG. 16 illustrates further details of state 704 in FIG. 7 and principles of FIG. 9. A 3D Gaussian scene 1600 is shown from a virtual camera location 1602. The cube 1604 represents the 3D Gaussian scene with plane for sorting Gaussians by depth as indicated at 1606. FIG. 16 illustrates that Gaussian splatting may be rendered using GPU resources. Meaning that projection, sorting, and rendering may be implemented using CUDA in which each parallel unit of block and thread corresponds to a rectangular area and one pixel on the image, with color and transparency accumulating according to the sorted list of objects. The Gaussian/plane information can be preloaded to GPU memory in advance to accelerate the rendering process.

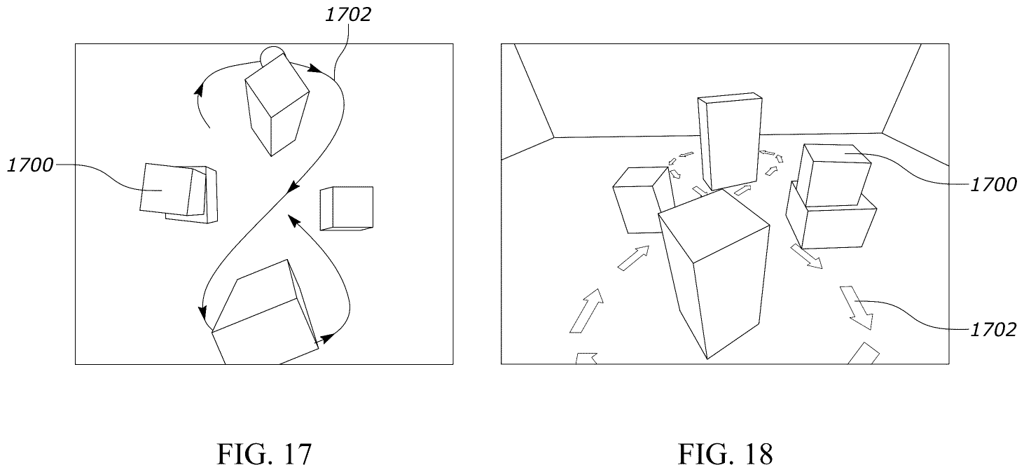

FIGS. 17 and 18 respectively represent a bird's eye view of a Gaussian representation of a video scene and a third person view of the same scene. Note that Gaussian representations 1700 of objects in the original video are shown along with user-input content 1702, in the example shown, a path drawn to be followed around the objects. Depending on the view, different portions of the user-input content are occluded from one view to the next as shown. Because the object can move and the camera also can move, the projected plane parameters including position, rotation, texture and occlusion should be recalculated on a frame-by-frame basis.

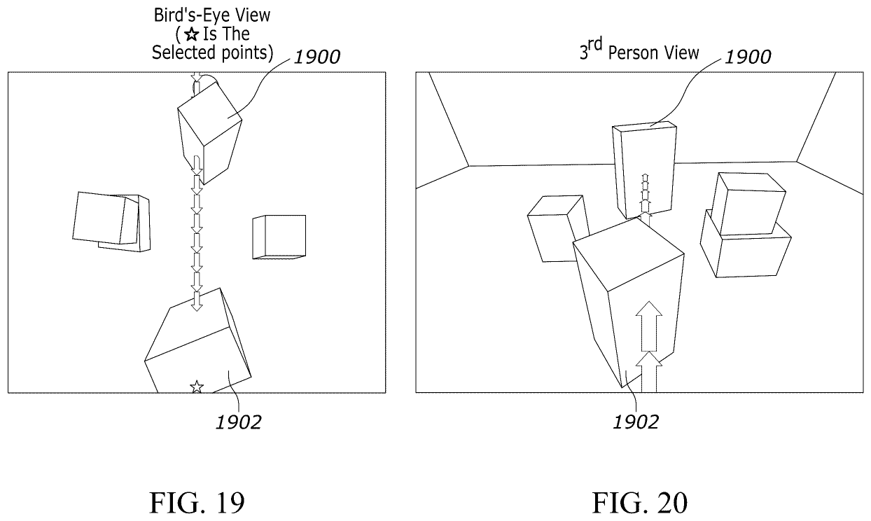

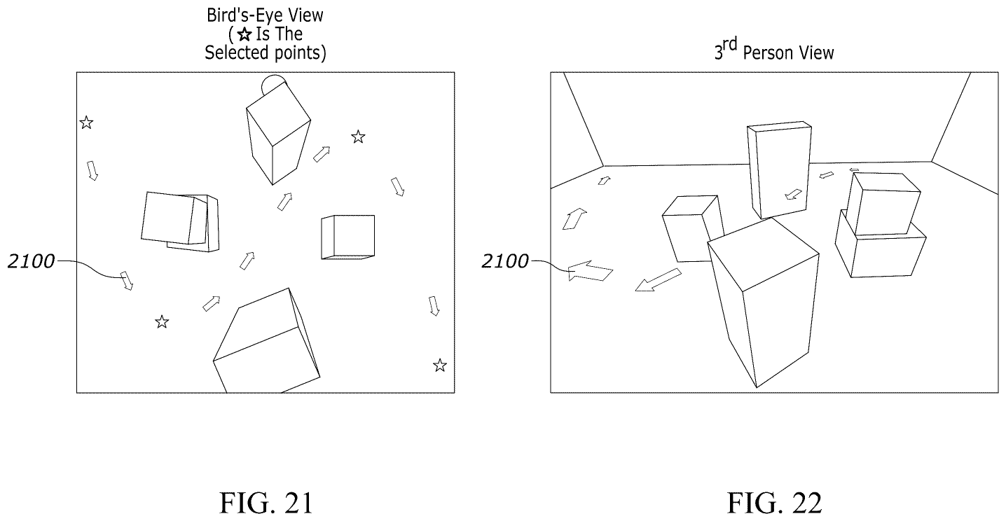

FIGS. 19 and 20 illustrate respective bird's eye and third person views of user-indicated desire to create a path between two objects 1900, 1902 in the 3D representation of space by simply selecting two or more points in the space, such as the center points of the objects 1900 and 1902. FIGS. 21 and 22 on the other hand illustrate respective bird's eye and third person views of the resultant path or trajectory 2100 that the system may automatically construct based on the user-indicated desire. It is to be appreciated that the path 2100 is generated to avoid touching any of the Gaussian representations of objects in the space, with appropriate portions of the path 2100 being occluded dependent on the particular camera view.

Additional used cases may include enabling a user to decorate a scene responsive to, e.g., good game play by inputting content to decorate objects in the scene.

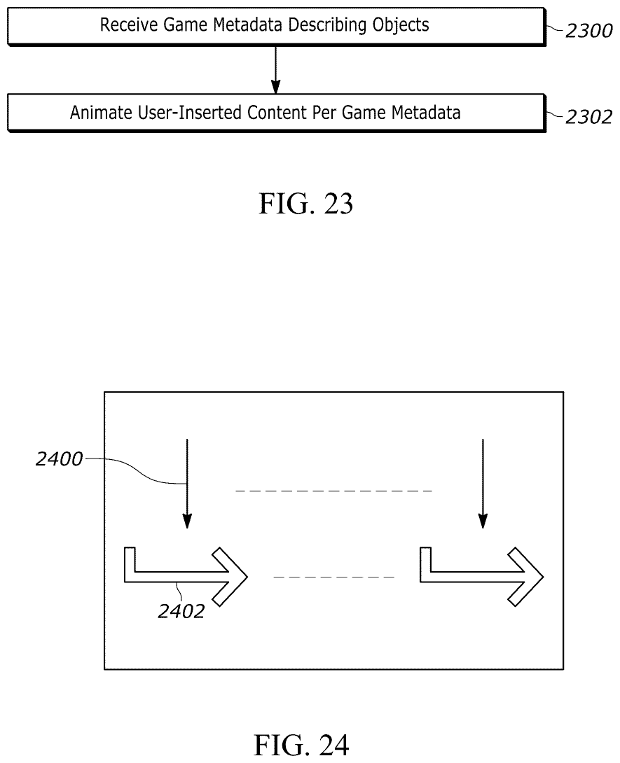

Another example use case is illustrated by FIG. 23. Commencing at state 2300, game metadata is received describing one or more game objects. Moving to state 2302, user-input content is animated or otherwise altered according to the game metadata.

As a few non-limiting examples, if user-input content is a post it note with a message attached to a game object, the message might change depending on game metadata. For instance, if the user-input content is a note to blow up a game object, and the object is subsequently destroyed according to game metadata, the message may change to a congratulatory message, or the message itself may be animated to be torn into pieces. Similarly, if the user-input content is a drawing of a game path for a player to follow and a game object is dropped into the path as indicated by the game metadata, the path can automatically change to route around the new object. Yet again, if the user-input content is a drawing of a fawn at rest, and the game metadata indicates that an ogre has entered the scene, the fawn can be animated to rise and run away.

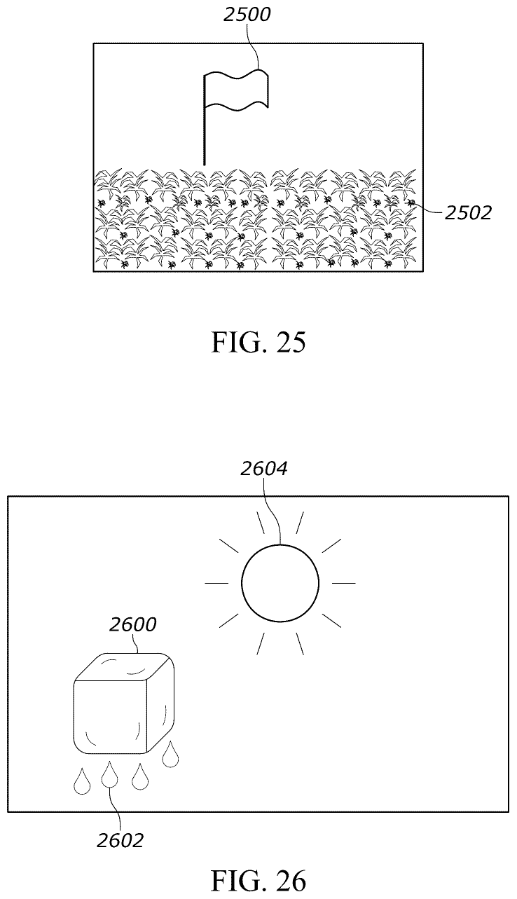

Additional examples of animating and/or altering the user-input content include user-input content that inherits properties of existing objects in a scene. For example, as shown in FIG. 24, an inserted arrow 2400 can hover over an existing object 2402 (such as a plane) in a game video and move along a trajectory specified by that object to track the object. As another example, FIG. 25 illustrates an inserted object 2500 that oscillates at a specific frequency based on the movement of one or more existing objects in the game or video scene. In FIG. 25, the object 2500 is a flag that is animated to be blowing in the wind based on the movement of grass 2502 in the scene.

Also, user-inserted content may be shaded based on video or game scene lighting.

The logic at state 2302 may also include physically altering user-inserted content based on scene context. For example, FIG. 26 illustrates an inserted object 2600 such as an ice cube that is animated to melt (as indicated by the water drops 2602) when placed in direct view of the sun 2604 that is part of an outdoor scene in a game or other video. Similarly, a user-input content can be animated to freeze when placed in a cold outdoor environment during winter as simulated in a computer game.

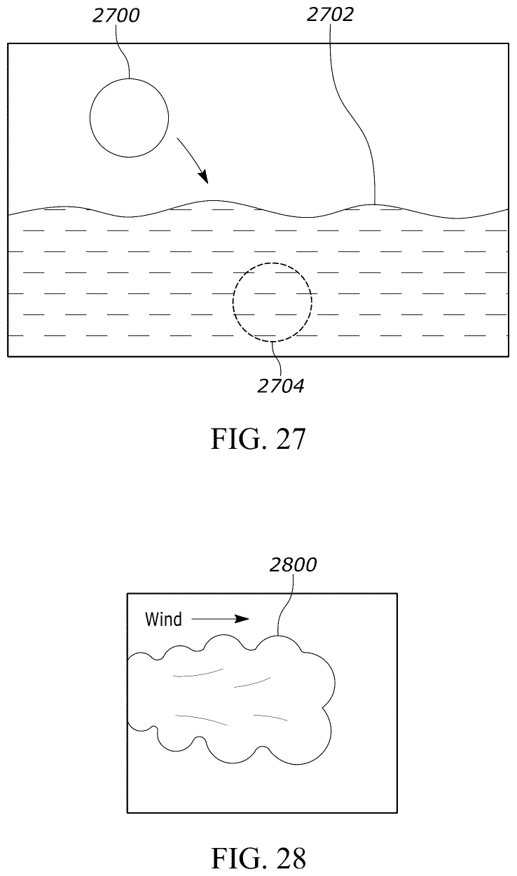

FIG. 27 illustrates an object 2700 that falls into water 2702 in a game scene and dissolves as indicated by the dashed lines 2704. FIG. 28 illustrates user-input smoke 2800 that billows in the wind indicated by game metadata. Existing volumetric lighting or volumetric shapes of user-input content can thus vary/be animated based on the metadata from the computer simulation.

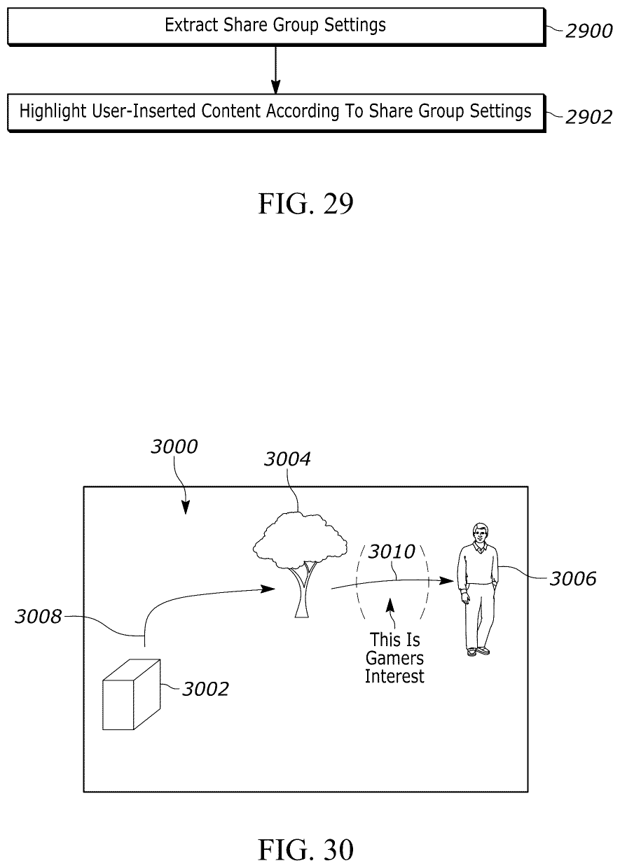

FIGS. 29 and 30 illustrate a further example use case. State 2900 indicates that shared group settings may be extracted from a game system. Proceeding to state 2902, using the settings user-input content may be highlighted for example. This is illustrated in FIG. 30. A video game scene 3000 includes game objects such as a box 3002, tree 3004, and character 3006 along with user-input content in the form of a preferred path 3008. A portion 3010 of the path 3008 may be highlighted to indicate that the shared group settings indicate that a number of gamers find that portion of the game space to be interesting.

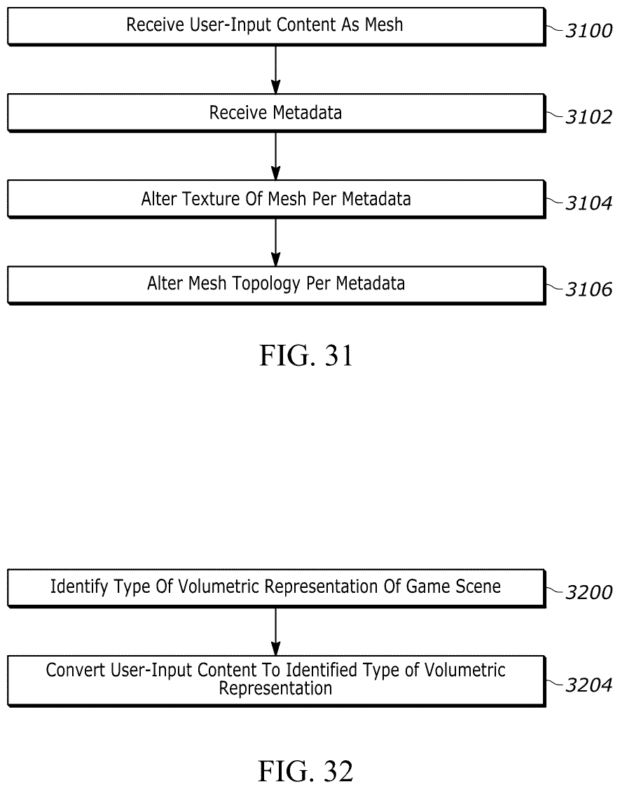

FIG. 31 illustrates logic for inserting user-input 2D planar and/or 3D mesh objects. Commencing at state 3100, the user-input content is received as a mesh, either 2D or 3D. Metadata from the computer game into which the user-input content is to be inserted is received at state 3102. Then, states 3104 and 3106 respectively indicate that the texture of the mesh is altered according to the game metadata, and/or the mesh topology itself is altered according to the game metadata.

On the other hand, FIG. 32 illustrates merging a volumetric representation of user-input content with the game scene volumetric representation. Commencing at state 3200, the type of volumetric representation of the game scene from, e.g., state 400 in FIG. 4 is identified. Moving to state 3202, the user-input content is converted to a volumetric representation matching the type identified at state 3200.

An example use case of the above is creating a volumetric representation of a physical space such as a living room and a separate volumetric representation of a game being presented on a display in the physical space. Objects represented as collections of gaussians can be moved between the two representations. For example, objects from the game can be pulled into the representation of the physical space.

While the particular embodiments are herein shown and described in detail, it is to be understood that the subject matter which is encompassed by the present invention is limited only by the claims.

What is claimed is:

1. An apparatus comprising:
at least one processor system configured to:
receive information from video;
using the information, convert at least one scene in the video to a three-dimensional (3D) representation of space comprising at least a first volumetric representation of at least a first object in the video;
receive user-input content;
insert the user-input content into the 3D representation of space;
responsive to identifying at least a first portion of the user-input content as being occluded by the first volumetric representation, not render the first portion of the user-input content;
set opacity of the first volumetric representation to zero; and
overlay the user-input content with first volumetric representation whose opacity is zero onto the video for presentation of the video with the user-input content.

2. The apparatus of claim 1, wherein the first volumetric representation comprises a spatially localized basis function.

3. The apparatus of claim 1, wherein the first volumetric representation comprises Gaussians.

4. The apparatus of claim 1, wherein the user-input content comprises a drawing of a path through a game world.

5. The apparatus of claim 1, wherein the processor system is configured to convert the user-input content to a volumetric representation.

6. The apparatus of claim 1, wherein the user-input content comprises at least one texture.

7. The apparatus of claim 1, wherein the user-input content comprises at least one two dimensional (2D) object.

8. The apparatus of claim 1, wherein the processor assembly is configured to:
use a combination of motion vectors and semantic information about objects in the video to identify at least a first object with which to align the user-input content; and
align the user-input content with Gaussians of the first object in the 3D representation of space.

9. The apparatus of claim 8, wherein the semantic information comprises geometry/shape correspondence of the first object and color/texture correspondence of the first object.

10. The apparatus of claim 3, wherein the processor system is configured to:
prune at least some Gaussians from the 3D representation of space prior to inserting the user-input content into the 3D representation of space.

11. The apparatus of claim 10, wherein the processor system is configured to:
prune at least some Gaussians from the 3D representation of space based at least in part on opacity of the Gaussians.

12. A method comprising:
generating, from a video, a three dimensional (3D) representation of space comprising Gaussians representing objects in the video;
inserting into the 3D representation of space a user-input content;
setting opacity of Gaussians in the 3D representation of space to zero such that Gaussians representing objects in the video are transparent and only one or more portions of the user-input content are not transparent; and
combining the 3D representation of space with the video.

13. The method of claim 12, wherein the user-input content comprises a drawing of a path through a game world.

14. The method of claim 12, comprising:
using a combination of motion vectors and semantic information about objects in the video to identify at least a first object with which to align the user-input content; and
aligning the user-input content with Gaussians of the first object in the 3D representation of space.

15. The method of claim 12, comprising:
pruning at least some Gaussians from the 3D representation of space prior to inserting the user-input content into the 3D representation of space.

16. The method of claim 12, comprising:
pruning at least some Gaussians from the 3D representation of space based at least in part on opacity of the Gaussians.

17. A device, comprising:
computer memory not a transitory signal, the computer memory comprising instructions executable by at least one processor system to:
create, from a video, a three dimensional (3D) representation of space, the 3D representation of space comprising volumetric representations of objects in the video;
receive user-input content into the 3D representation of space;
make the volumetric representations transparent; and
combine the 3D representation of space with the video such that the user-input content appears with the video but the volumetric representations do not.

18. The device of claim 17, wherein the volumetric representations comprise Gaussians.

19. The device of claim 17, wherein the instructions are executable to:
align the user-input content with at least one of the volumetric representations; and
responsive to a portion of the user-input content being blocked from a camera view by one of the volumetric representations, set an opacity of the portion to zero.

20. The device of claim 17, wherein he user-input content comprises a game path.
